(19) United States
(12) Patent Application Publication
(10) Pub. No.: US 2016/0077822 A1
(43) Pub. Date: Mar. 17, 2016

(54) ELECTRONIC DEVICE AND INFORMATION UPDATING CONTROL MODULE THEREOF

(71) Applicant: proeasy network solutions co., LTD., Hsinchu County (TW)

(72) Inventor: Hsing-Hung Lu, Hsinchu County (TW)

(21) Appl. No.: 14/584,912

(22) Filed: Dec. 29, 2014

(30) Foreign Application Priority Data
Sep. 11, 2014 (TW) 103131330

(51) Int. Cl. G06F 9/445

(52) U.S. Cl. CPC G06F 8/65

(57) ABSTRACT

An electronic device and an information updating control module that includes a processing unit, a system reset button, and an identification updating button are provided. The system reset button is coupled to the processing unit. The identification updating button is coupled to the processing unit. The processing unit is configured to determine whether a first trigger status corresponding to the system reset button and a second trigger status corresponding to the identification updating button comply with a predetermined rule. If the first trigger status corresponding to the system reset button and the second trigger status corresponding to the identification updating button comply with the predetermined rule, the processing unit is configured to receive a new identification and update an identification of an electronic device by applying the new identification.

### CROSS-REFERENCE TO RELATED APPLICATION

This application claims the priority benefit of Taiwan application serial no. 103131330, filed on Sep. 11, 2014. The entirety of the above-mentioned patent application is hereby incorporated by reference herein and made a part of this specification.

### FIELD OF THE INVENTION

The invention relates to a control module. More particularly, the invention relates to an information updating control module and an electronic device including the information updating control module.

### DESCRIPTION OF RELATED ART

Since the last half a century, the development in the field of computers has been prosperous. Such development allows a variety of automation equipment (e.g., washing machines, dishwashers, and sweeping robots) to be extensively applied in daily lives. Besides, owing to changes to the household population structure as well as the work style in the modern society, the manual labor devoted to household chores has been gradually replaced by machines. Meanwhile, integrated solutions aiming at coordinating, managing, and controlling various home appliances or equipment, such as lightings, televisions, security systems, air conditioners, audiovisual systems, and so on, now constantly hit the market.

To set up a home automation control system that can be applied to manage various electronic devices, at least one host system may be configured to control or maintain one or more electronic devices through controlling one or more information updating control modules correspondingly arranged on the electronic devices. Therefore, how to enable a user to conveniently update or maintain important information in each information updating control module is certainly an issue for researchers in this field to work on.

### SUMMARY OF THE INVENTION

The invention is directed to an electronic device and an information updating control module of the electronic device which allows a user to conveniently update or maintain important information in the electronic device.

In an embodiment of the invention, an information updating control module that includes a processing unit, a system reset button, and an identification (ID) updating button is provided. The system reset button is coupled to the processing unit. The ID updating button is coupled to the processing unit. The processing unit is configured to determine whether a first trigger status corresponding to the system reset button and a second trigger status corresponding to the ID updating button comply with a predetermined rule.

If the first trigger status corresponding to the system reset button and the second trigger status corresponding to the ID updating button comply with the predetermined rule, the processing unit is configured to receive a new ID and update an ID of an electronic device by applying the new ID.

According to an embodiment of the invention, the information updating control module further includes a software/firmware updating button. The software/firmware updating button is coupled to the processing unit. The processing unit is further configured to determine whether the first trigger status corresponding to the system reset button and a third trigger status corresponding to the software/firmware updating button comply with the predetermined rule. If the first trigger status corresponding to the system reset button and the third trigger status corresponding to the software/firmware updating button comply with the predetermined rule, the processing unit is further configured to receive new information configured to modify at least one function of the electronic device.

According to an embodiment of the invention, if each of the first trigger status and the second trigger status is an enabling status, the processing unit is further configured to determine an enabling time frame during which the first trigger status and the second trigger status are both the enabling statuses. If the enabling time frame is longer than a predetermined time frame, the processing unit is further configured to determine whether the first trigger status is a disabling status. If the first trigger status is the disabling status, the processing unit determines the first trigger status corresponding to the system reset button and the second trigger status corresponding to the ID updating button comply with the predetermined rule.

According to an embodiment of the invention, if the first trigger status corresponding to the system reset button and the second trigger status corresponding to the ID updating button comply with the predetermined rule, the processing unit is further configured to issue an ID updating request to a host system and determine whether the new ID is received from the host system. If the new ID is received from the host system, the processing unit is configured to store the new ID into the electronic device and define the new ID as the ID of the electronic device.

According to an embodiment of the invention, the new ID is issued by a host system.

In an embodiment of the invention, an electronic device that includes an information updating control module is provided. The information updating control module includes a processing unit, a system reset button, and an ID updating button. The system reset button is coupled to the processing unit. The ID updating button is coupled to the processing unit. The processing unit is configured to determine whether a first trigger status corresponding to the system reset button and a second trigger status corresponding to the ID updating button comply with a predetermined rule. If the first trigger status corresponding to the system reset button and the second trigger status corresponding to the ID updating button comply with the predetermined rule, the processing unit is further configured to receive a new ID and update an ID of the electronic device by applying the new ID.

In view of the above, through triggering certain buttons of the information updating control module, the user can conveniently update the ID of the electronic device and other information in no need of undergoing complicated procedures, and thereby the management efficiency of the electronic device can be enhanced.

Several exemplary embodiments accompanied with figures are described in detail below to further describe the invention in details.

### BRIEF DESCRIPTION OF THE DRAWINGS

FIG. 1 is a schematic view illustrating a control system of electronic devices according to an embodiment of the invention.

FIG. 2 is a brief block diagram illustrating an information updating control module according to an embodiment of the invention.

FIG. 3 is a schematic view illustrating an information updating control module according to an embodiment of the invention.

FIG. 4 is a schematic view illustrating an information updating control module according to another embodiment of the invention.

FIG. 5 is a flowchart illustrating an information updating method according to an embodiment of the invention.

### DETAILED DESCRIPTION OF DISCLOSED EMBODIMENTS

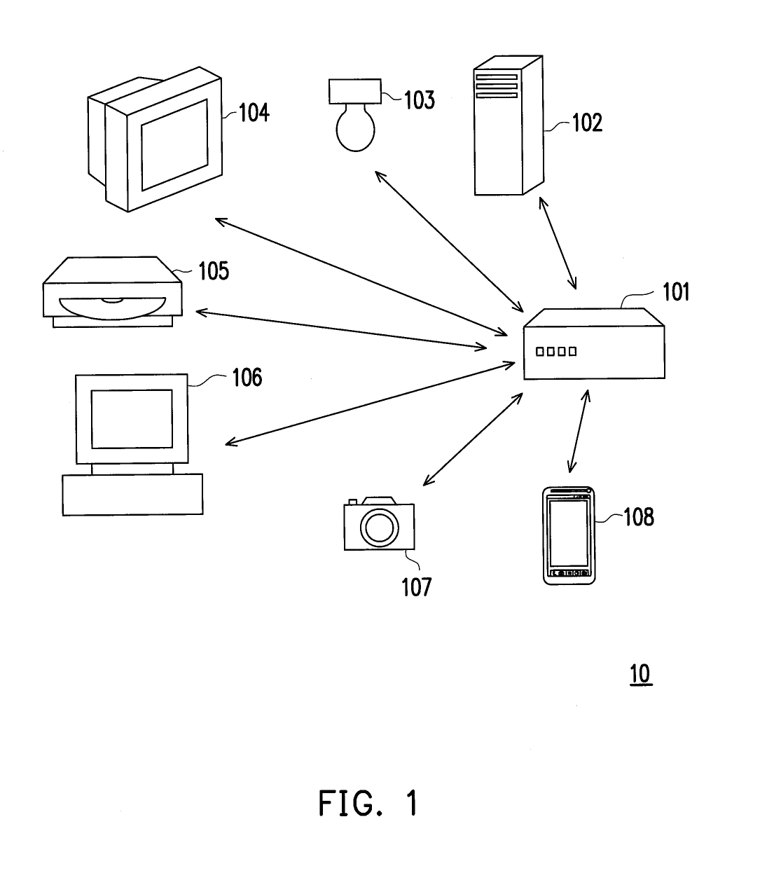

FIG. 1 is a schematic view illustrating a control system of electronic devices according to an embodiment of the invention.

With reference to FIG. 1, the control system 10 includes a host system 101 and electronic devices 102-108. The descriptions of the electronic devices 102-108 and the host system 101 provided in the following embodiment are merely explanatory and should not be construed as limitations to the invention. In the control system 10, the number of electronic devices should not be limited; for instance, in other embodiments of the invention, the number of the electronic device may be one or more, and so is the number of the host system. In the following embodiments, the descriptions of the interaction between one electronic device and one host system as well as the interaction between one electronic device and other electronic devices should not be construed as limitations to the invention.

The host system 101 is the central control device of the control system 10; according to the manufacturer's setup, the host system 101 may be applied to control, maintain, and manage the electronic devices 102-108 through the operation of a user. In addition, as shown in FIG. 1, the information communication between the host system 101 and the electronic devices 102-108 may be implemented in a wireless manner, which should however not be construed as a limitation to the invention, i.e., such information communication may also be implemented in a wired manner, e.g., through cables or power lines.

With reference to FIG. 1, each of the electronic devices 102-108 may be a power device, a lighting device, a security device, an air conditioner, an audio-visual entertainment device, and so forth. For instance, given that the electronic device 103 is a lighting device, the electronic device 103 may be correspondingly switched on or off according to the control command issued by the host system 101. Given that the electronic device 105 is an audio-visual entertainment device, the electronic device 105 may, according to the control command issued by the host system 101, play a multimedia file in a normal manner, a fast-forward manner, or a fast-backward manner, or stop playing the multimedia file. One electronic device may also send information to the host system for information management.

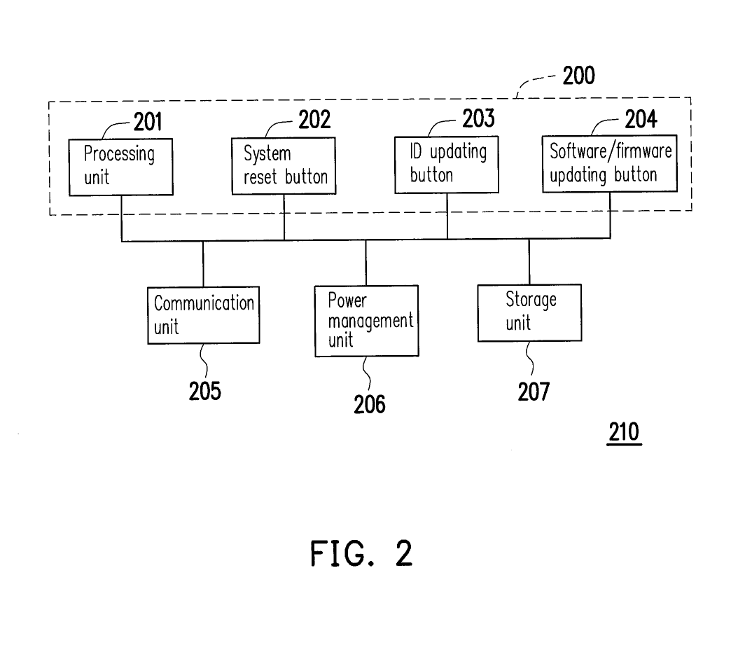

FIG. 2 is a brief block diagram illustrating an information updating control module according to an embodiment of the invention.

With reference to FIG. 2, the electronic device 210 includes an information updating control module 200. The electronic device 210 may be any of the electronic devices 102-108 or a home appliance controller corresponding to at least one of the electronic devices 102-108. If the electronic device 210 is a home appliance controller corresponding to at least one of the electronic devices 102-108, the electronic device 210 may control at least one of the electronic devices 102-108 according to a control command issued by the host system 101. For instance, the electronic device 210 may control at least one of the electronic devices 102-108 to perform a function corresponding to the control command.

According to the present embodiment, the information updating control module 200 includes a processing unit 201, a system reset button 202, an ID updating button 203, and a software/firmware updating button 204. The system reset button 202, the ID updating button 203, and the software/firmware updating button 204 are respectively coupled to the processing unit 201. Here, the arrangement of the software/firmware updating button 204 is optional. In another exemplary embodiment of the invention, the information updating control module 200 may further include a communication unit 205, a power management unit 206, and a storage unit 207. The electronic device 210 may not include the power management unit 206 in still another exemplary embodiment.

The processing unit 201 is hardware having the processing capabilities, e.g., a microprocessor or a chipset, and the processing unit 201 is configured to control the overall operation of the information updating control module 200. The processing unit 201 may also serve to control the overall operation of the electronic device 210. In the present embodiment, the processing unit 201 is, for instance, a central processing unit (CPU), a microprocessor, any other programmable microprocessor, a digital signal processor (DSP), a programmable controller, an application specific integrated circuit (ASIC), a programmable logic device (PLD), or any other similar device.

The communication unit 205 is coupled to the processing unit 201 for transmitting or receiving data through wireless communication. According to the present embodiment, the communication unit 205 may have a wireless communication module (not shown) that supports a global system for mobile communication (GSM), a personal handy-phone system (PHS), a code division multiple access (CDMA) system, a wireless fidelity (WiFi) system, a worldwide interoperability for microwave access (WiMAX) system, a three-generation (3G) wireless communication system, a long term evolution (LTE) system, an infrared transmission system, a Bluetooth communication system, or a combination thereof; however, the invention is not limited thereto.

In addition, the communication unit 205 may be equipped with a wired communication module (not shown) for transmitting or receiving data through cables. The wired communication module may be an optical fiber network module and may be connected to the host system 101 through an optical fiber interface and optical fibers. In the resultant optical fiber network, information may be transmitted between the host system 101 and the information updating control module 200. The type and the material of the optical fibers are not limited herein. For instance, the optical fibers may include and should not be limited to single-mode or multi-mode optical fibers. In an embodiment of the invention, the optical fibers may be applied together with the power lines.

For instance, if the electronic device 210 is the electronic device 102 which is assumed to be an air conditioner, and if the room temperature at home is detected by the electronic device 102 and is to be transmitted to the host system 101 through the information updating control module 200, the user may connect the host system 101 in a wireless manner (e.g., via Bluetooth) through an application program installed in the mobile phone, and such an application program can then inform the user of the current room temperature (e.g., 30° C.) at home. If the user intends to lower down the room temperature, the user may send a control command for controlling the electronic device 102 (e.g., for setting the target room temperature to be 25° C.) to the host system 101 through the application program. After receiving the control command, the host system 101 sends a control signal to the information updating control module 200 to activate the electronic device 102 and set the target room temperature of the electronic device 102 to be 25° C.

The power management unit 206 is coupled to the processing unit 201 for managing the power supply of the electronic device 210.

The storage unit 207 is coupled to the processing unit 201. According to the instruction of the processing unit 201, the storage unit 207 is able to store data temporarily, and the data include data for managing the electronic device 210, data received from the host system 101, data to be transmitted to the host system 101, or any other data, which should not be contoured as limitations to the invention. Besides, the storage unit 207 may further record some data which takes longer time to be stored according to the instruction of the processing unit 201, e.g., the ID corresponding to the information updating control module 200 or the electronic device 210, the firmware or software configured to manage the information updating control module 200 or the electronic device 210, etc. According to another exemplary embodiment, the storage unit 207 may be included in the processing unit 201.

The ID may be an ID code, a personal identification number (PIN), or any other information that may be applied to identify the information updating control module 200 or the electronic device 210, and the invention is not limited thereto. Besides, the processing unit 201 may control the information updating control module 200 or the electronic device 210 by executing the firmware or the software.

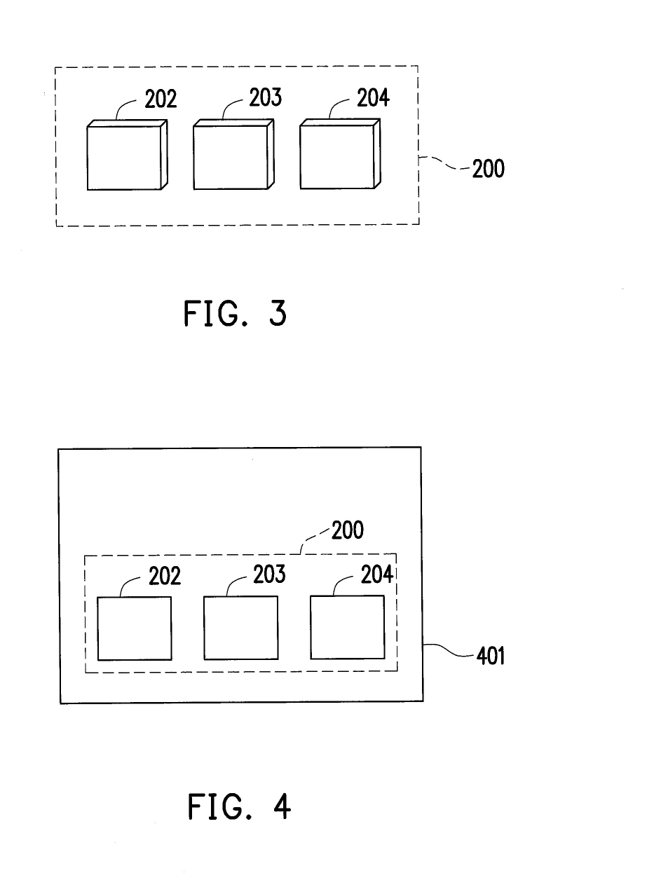

FIG. 3 is a schematic view illustrating an information updating control module according to an embodiment of the invention.

With reference to FIG. 3, in the present embodiment, the system reset button 202, the ID updating button 203, and the software/firmware updating button 204 are a physical button, respectively, and these buttons 202, 203, and 204 can be arranged on the casing of the electronic device 210. In another embodiment of the invention, the system reset button 202, the ID updating button 203, and the software/firmware updating button 204 may be arranged within the electronic device 210. The processing unit 201 determines whether the trigger status corresponding to the system reset button 202, the trigger status corresponding to the ID updating button 203, and the trigger status corresponding to the software/firmware updating button 204 comply with the predetermined rule, so as to decide the predetermined operation to be performed.

Specifically, if the system reset button 202 senses a trigger operation (e.g., a pressing operation), the system reset button 202 sends a first control signal to the processing unit 201. Once the processing unit 201 receives the first control signal, the processing unit 201 determines that the trigger status (i.e., the first trigger status) corresponding to the system reset button 202 is an enabled status. In view of the above, the method of determining whether the trigger status corresponding to the ID updating button 203 and the trigger status corresponding to the software/firmware updating button 204 are the enabled statuses is similar to the method of determining whether the trigger status corresponding to the system reset button 202 is the enabled status, and therefore no further description is provided below.

If the system reset button 202 does not sense any trigger operation corresponding to the system reset button 202, the system reset button 202 does not send any first control signal to the processing unit 201. Once the processing unit 201 does not receive the first control signal, the processing unit 201 determines that the trigger status (i.e., the first trigger status) corresponding to the system reset button 202 is a disabled status. In view of the above, the method of determining whether the trigger status corresponding to the ID updating button 203 and the trigger status corresponding to the software/firmware updating button 204 are the disabled statuses is similar to the method of determining whether the trigger status corresponding to the system reset button 202 is the disabled status, and therefore no further description is provided below.

According to the present embodiment, as long as the processing unit 201 receives the first control signal, the processing unit 201 “immediately” determines that the first trigger status corresponding to the system reset button 202 is the enabled status; however, the invention is not limited thereto. For instance, in another embodiment of the invention, the method of determining the first trigger status corresponding to the system reset button 202 may be performed in the following manner: if the processing unit 201 continuously receives the first control signal for more than a first predetermined time frame, or if the processing unit 201 constantly receives the first control signal at different times within a second predetermined time frame, the processing unit 201 determines that the first trigger status corresponding to the system reset button 202 is the enabled status.

The processing unit 201 provided in the present embodiment continues to determine whether the first trigger status corresponding to the system reset button 202 and the second trigger status corresponding to the ID updating button 203 comply with a predetermined rule. If the first trigger status corresponding to the system reset button 202 and the second trigger status corresponding to the ID updating button 203 comply with the predetermined rule, the processing unit 201 starts to perform an ID updating operation.

According to the present embodiment, in the ID updating operation, the processing unit 201 sends an ID updating request to the host system 101 through the communication unit 205. If the processing unit 201 receives the new ID from the host system 101 in response to the ID updating request, the processing unit 201 stores the new ID into the storage unit 207. Besides, the processing unit employs the received new ID to update the ID of the electronic device 210. According to another exemplary embodiment, the processing unit 201 also employs the received new ID to update the ID of the information updating control module 200. The processing unit 201 described in still another embodiment of the invention may not send any ID updating request and may merely wait for the new ID.

According to the present embodiment, the host system 101 is in charge of managing and allocating the ID information of every information updating control module/electronic device. As long as the host system 101 receives the ID updating request from the information updating control module 200 or the electronic device 210, the host system 101 transmits the new ID corresponding to the information updating control module 200 or the electronic device 210 to the information updating control module 200 or the electronic device 210. Note that the way to manage and allocate the ID information by the host system 101 is not limited herein; for instance, in an embodiment of the invention, the host system 101 issues a new ID to the information updating control module 200 according to an information updating control module list. In another exemplary embodiment, the host system 101 generates a new ID according to the characteristics of the information updating control module 200/the electronic device 210, the inherent hardware information of the information updating control module 200/the electronic device 210, and other specific information, and the generated new ID is given to the information updating control module 200/the electronic device 210 in response to the ID updating request.

According to the present embodiment, if both the first trigger status and the second trigger status comply with the predetermined rule, i.e., if both the first trigger status and the second trigger status are the enabled statuses, the processing unit 201 then determines a time frame (i.e., an enabled time frame) during which the first trigger status and the second trigger status are both the enabled statuses. If the enabled time frame is longer than a predetermined time frame (e.g., one second), the processing unit 201 continues to determine whether the first trigger status is converted from the enabled status to a disabled status. If the first trigger status is the disabled status, the processing unit 201 determines the first trigger status corresponding to the system reset button 202 and the second trigger status corresponding to the ID updating button 203 comply with the predetermined rule. That is, according to the present embodiment, the predetermined rule is complied with: “the first trigger status is converted to be the disabled status when the enabled time frame during which the first trigger status and the second trigger status are both the enabled statuses exceeds the predetermined time frame”. That is, after the system reset button 202 and the ID updating button 203 are triggered for a period of time (e.g., the enabled time frame), if the system reset button 202 is no longer triggered, the processing unit 201 starts to perform the ID updating operation. However, the invention is not limited thereto; according to another exemplary embodiment, the predetermined rule is complied with: “the second trigger status is converted to be the disabled status when the enabled time frame during which the first trigger status and the second trigger status are both the enabled statuses exceeds the predetermined time frame.” Alternatively, the predetermined rule is complied with: “the second trigger status is converted to be the enabled status when the enabled time frame during which the first trigger status is the enabled status exceeds the predetermined time frame.”

According to another exemplary embodiment, the transmitted new ID information may include simple authentication information, e.g., an IP address, a MAC address, etc. Here, the authentication information is applied to instruct the information updating control module to perform the ID updating operation. For instance, if the authentication information included in one ID instructs the electronic device 210 to perform the ID updating operation, only the electronic device 210 receives the new ID and thereby updates its ID.

With reference to FIG. 2 and FIG. 3, in an exemplary embodiment, the processing unit 201 determines whether the first trigger status corresponding to the system reset button 202 and a second trigger status corresponding to the software/firmware updating button 204 comply with the predetermined rule. If the first trigger status corresponding to the system reset button 202 and the third trigger status corresponding to the software/firmware updating button 204 comply with the predetermined rule, the processing unit 201 performs an information updating operation. After the processing unit 201 receives the new information from the host system 101, the processing unit 201 may modify at least one function of the information updating control module 200 or the electronic device 210 according to the received new information. The information updating operation is exemplified below as a firmware updating operation.

Similar to the ID updating operation, according to the present embodiment, in the firmware updating operation, the processing unit 201 sends a firmware updating request to the host system 101 through the communication unit 205. If the processing unit 201 receives the new firmware from the host system 101 in response to the firmware updating request, the processing unit 201 stores the new firmware into the storage unit 207. The received new firmware may be employed by the processing unit 210 to update the firmware of the information updating control module 200 or the firmware of the electronic device 210. According to the updated firmware, the processing unit 201 is able to modify the function or the operation of the information updating control module 200 or the electronic device 210. In the present embodiment, if the host system 101 receives the firmware updating request, the host system 101 may accordingly check whether the firmware of the information updating control module 200 (or the electronic device 210) is required to be updated. Given the firmware of the information updating control module 200 (or the electronic device 210) is required to be updated, the host system 101 transmits the new firmware corresponding to the information updating control module 200 to the information updating control module 200. Given the firmware of the information updating control module 200 (or the electronic device 210) need not be updated, the host system 101 may or may not transmit the new firmware corresponding to the information updating control module 200.

In another exemplary embodiment, the software/firmware updating button 204 may be called as a “boot loader button”. If the third trigger status corresponding to the software/firmware updating button 204 complies with the predetermined rule, a boot loader program may be executed to update the firmware according to the received new firmware, or an initialization program may be executed to initialize the hardware.

It should be mentioned that the firmware represents the so-called information according to the present exemplary embodiment, while the invention is not limited thereto. For instance, in another exemplary embodiment, the information may be software or an application program installed in the information updating control module 200/the electronic device 210. Through the information updating operation provided herein, the information updating control module 200 or the electronic device 210 is capable of obtaining the latest software from the host system 101 and enhance/modify the functions that can be performed by the information updating control module 200 or the electronic device 210. The method of obtaining the latest information corresponding to the information updating control module 200 or the electronic device 210 by the host system 101 is not limited in the invention. For instance, the host system 101 may automatically update the information corresponding to the information updating control module 200 or the electronic device 210 through internet, or the user may manually control the host system 101 to obtain the latest information.

Note that parts of the electronic device 210 or the entire electronic device 210 may be combined with non-electronic objects according to an embodiment of the invention, such that the host system 101 is able to manage the non-electronic objects. For instance, in an embodiment of the invention, if the information updating control module 200 and the communication unit 205 in the electronic device 210 are configured on a work permit (e.g., a non-electronic object) serving to identify a user, the user holding the work permit may perform the ID updating operation on the work permit while the user is working at different factories. For instance, the ID of the user himself or herself is logged in the host system 101 of a factory where the user is working. The managing staff of such a factory may manage or instruct the working staff by means of the host system 101 and the work permit of the user.

Note that the system reset button 202, the ID updating button 203, and the software/firmware updating button 204 provided in the embodiment shown in FIG. 3 are physical buttons, for instance. In another embodiment of the invention, however, the system reset button 202, the identification updating button 203, and the software/firmware updating button 204 may be virtual buttons.

FIG. 4 is a schematic view illustrating an information updating control module according to another embodiment of the invention.

The difference between the information updating control module 200 shown in FIG. 4 and the information updating control module 200 depicted in FIG. 3 lies in that the screen 401 displays the system reset button 202, the identification updating button 203, and/or the software/firmware updating button 204 corresponding to the information updating control module 200 shown in FIG. 4. In the present embodiment, the screen 401 is a touch screen. Through clicking on the screen 401, the user is able to trigger at least one of the system reset button 202, the identification updating button 203, and the software/firmware updating button 204. For instance, once the user clicks on the system reset button 202, the processing unit 201 determines the trigger status corresponding to the system reset button 202 is the enabled status (i.e., the system reset button 202 is triggered), and other operations of the processing unit 201 may be deduced from the above.

In an exemplary embodiment, if the screen 401 is not a touch screen, the user may select a to-be-triggered button on the screen 401 through a remote control or an input device. In addition to the physical buttons or the virtual buttons described above, the system reset button 202, the identification updating button 203, and the software/firmware updating button 204 may be thermal-sensitive buttons, photo-sensitive buttons, magnetic-sensitive buttons, electric-sensitive buttons, or any other physical or virtual buttons equipped with other types of sensors. The invention is not limited thereto.

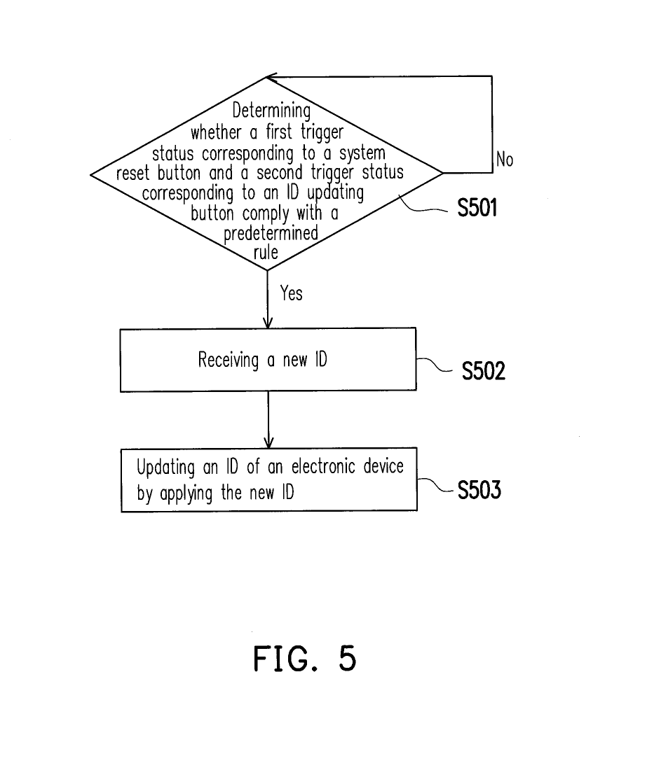

FIG. 5 is a flowchart illustrating an information updating method according to an embodiment of the invention.

With reference to FIG. 5, in step S501, whether a first trigger status corresponding to a system reset button and a second trigger status corresponding to an ID updating button comply with a predetermined rule is determined. If the first and second trigger statuses do not comply with the predetermined rule, the step S501 is repeated. If the first and second trigger statuses comply with the predetermined rule, a new ID is received in step S502. In step S503, the new ID is applied to update an ID of an electronic device.

Each step shown in FIG. 5 is elaborated above and will not be further explained below. It should be mentioned that each step shown in FIG. 5 may be implemented in form of programming codes or circuits; the invention is not thereby limited. Besides, the method illustrated in FIG. 5 may be applied with or without reference to the previous embodiments, which should however not be construed as a limitation to the invention.

To sum up, through determining whether the enabled status corresponding to certain buttons of the electronic device complies with the predetermined rule, the user is able to conveniently update the information (e.g., the ID) of the information updating control module or the electronic device in no need of undergoing complicated procedures. Besides, through wireless communication, the ID can be updated in an effective and convenient manner, and the management efficiency of the control system can be further enhanced.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. An information updating control module comprising:
a processing unit;
a system reset button coupled to the processing unit; and
an identification updating button coupled to the processing unit;
wherein the processing unit is configured to determine whether a first trigger status corresponding to the system reset button and a second trigger status corresponding to the identification updating button comply with a predetermined rule, and
if the first trigger status corresponding to the system reset button and the second trigger status corresponding to the identification updating button comply with the predetermined rule, the processing unit is configured to receive a new identification and update an identification of an electronic device by applying the new identification.

2. The information updating control module as recited in claim 1, further comprising:
a software/firmware updating button coupled to the processing unit,
wherein the processing unit is further configured to determine whether the first trigger status corresponding to the system reset button and a third trigger status corresponding to the software/firmware updating button comply with the predetermined rule, and
if the first trigger status corresponding to the system reset button and the third trigger status corresponding to the software/firmware updating button comply with the predetermined rule, the processing unit is further configured to receive new information configured to modify at least one function of the electronic device.

3. The information updating control module as recited in claim 1, wherein an operation of the processing unit determining whether the first trigger status corresponding to the system reset button and the second trigger status corresponding to the identification updating button comply with the predetermined rule comprises:
if each of the first trigger status and the second trigger status is an enabled status, accumulating an enabled time frame during which the first trigger status and the second trigger status are both the enabled statuses;
if the enabled time frame is longer than a predetermined time frame, determining whether the first trigger status is a disabled status; and
if the first trigger status is the disabled status, determining the first trigger status corresponding to the system reset button and the second trigger status corresponding to the identification updating button comply with the predetermined rule.

4. The information updating control module as recited in claim 1, wherein if the first trigger status corresponding to the system reset button and the second trigger status corresponding to the identification updating button comply with the predetermined rule, an operation of the processing unit receiving the new identification comprises:
if the first trigger status corresponding to the system reset button and the second trigger status corresponding to the identification updating button comply with the predetermined rule, issuing an identification updating request to a host system and determining whether the new identification from the host system is received; and
if the new identification from the host system is received, storing the new identification into the electronic device and defining the new identification as the identification of the electronic device.

5. The information updating control module as recited in claim 1, wherein the new identification is issued by a host system.

6. An electronic device comprising:
an information updating control module comprising:
a processing unit;
a system reset button coupled to the processing unit; and
an identification updating button coupled to the processing unit;
wherein the processing unit is configured to determine whether a first trigger status corresponding to the system reset button and a second trigger status corresponding to the identification updating button comply with a predetermined rule, and
if the first trigger status corresponding to the system reset button and the second trigger status corresponding to the identification updating button comply with the predetermined rule, the processing unit is further configured to receive a new identification and update an identification of the electronic device by applying the new identification.

7. The electronic device as recited in claim 6, wherein the information updating control module further comprises:
a software/firmware updating button coupled to the processing unit,
wherein the processing unit is further configured to determine whether the first trigger status corresponding to the system reset button and a third trigger status corresponding to the software/firmware updating button comply with the predetermined rule, and
if the first trigger status corresponding to the system reset button and the third trigger status corresponding to the software/firmware updating button comply with the predetermined rule, the processing unit is further configured to receive new information configured to modify at least one function of the electronic device.

8. The electronic device as recited in claim 6, wherein an operation of the processing unit determining whether the first trigger status corresponding to the system reset button and the second trigger status corresponding to the identification updating button comply with the predetermined rule comprises:
if both the first trigger status and the second trigger status are enabled statuses, accumulating an enabled time frame during which the first trigger status and the second trigger status are both the enabled statuses;
if the enabled time frame is longer than a predetermined time frame, determining whether the first trigger status is a disabled status; and
if the first trigger status is the disabled status, determining the first trigger status corresponding to the system reset button and the second trigger status corresponding to the identification updating button comply with the predetermined rule.

9. The electronic device as recited in claim 6, wherein if the first trigger status corresponding to the system reset button and the second trigger status corresponding to the identification updating button comply with the predetermined rule, an operation of the processing unit receiving the new identification comprises:
if the first trigger status corresponding to the system reset button and the second trigger status corresponding to the identification updating button comply with the predetermined rule, issuing an identification updating request to a host system and determining whether the new identification is received from the host system; and
if the new identification is received from the host system, storing the new identification into the electronic device and defining the new identification as the identification of the electronic device.

10. The electronic device as recited in claim 6, wherein the new identification is issued by a host system.
